(19) United States
(12) Patent Application Publication
(10) Pub. No.: US 2006/0001624 A1
(43) Pub. Date: Jan. 5, 2006

(54) Organic light emitting display and control method thereof

(76) Inventor: Jae Sung Lee, Seoul (KR)

Correspondence Address: CHRISTIE, PARKER & HALE, LLP, PO BOX 7068, PASADENA, CA, 91109-7068, US

(21) Appl. No.: 11/154,271

(22) Filed: Jun. 15, 2005

(30) Foreign Application Priority Data
Jun. 16, 2004 (KR) 2004-44683

(51) Int. Cl. G09G 3/32

(52) U.S. Cl. 345/82

(57) ABSTRACT

An organic light emitting display and a control method thereof, which can control brightness of an image displaying part depending on neighboring brightness. The organic light emitting display includes: an optical sensing part for outputting a sensed signal corresponding to a neighboring brightness; a gamma controller for outputting a gamma correction value corresponding to the sensed signal; a driver for outputting a selection signal and a gamma-corrected data signal according to the gamma correction value; and an image displaying part for displaying an image according to the data signal and the selection signal outputted from the driver. In this configuration, the display uses the gamma correction value corresponding to neighboring brightness and controls the brightness of the display to vary depending on the neighboring brightness, thereby lengthening lifespan of a pixel of the display and reducing power consumption.

### CROSS-REFERENCE TO RELATED APPLICATION

This application claims priority to and the benefit of Korean Patent Application No. 10-2004-0044683, filed on Jun. 16, 2004, in the Korean Intellectual Property Office, the entire content of which is incorporated herein by reference.

### BACKGROUND

1. Field of the Invention

The present invention relates to an organic light emitting display and a control method thereof, and more particularly, to an organic light emitting display and a control method thereof which can control brightness of an image displaying part depending on a neighboring brightness.

2. Discussion of Related Art

An organic electroluminescent display (or an organic light emitting display) is a display device based on a phenomenon that an exciton emits light of a specific wavelength in an organic thin film. The exciton is formed by recombination of an electron and a hole respectively injected from a cathode and an anode. Unlike a liquid crystal display (LCD), the organic electroluminescent display includes a self-emitting device, so that a separate light source is not needed. In the organic electroluminescent display, the brightness of an organic light emitting device or diode (OLED) varies according to the amount of current flowing into the organic light emitting device.

The organic electroluminescent display is classified into a passive matrix type and an active matrix type according to driving methods. In the case of the passive matrix type, the anode and the cathode are perpendicularly disposed and form a line to be selectively driven. The passive matrix type organic electroluminescent display can be easily formed due to a relatively simple structure, but is inadequate for forming a large-sized screen because it consumes a relatively large amount of power, and yet it drives each organic light emitting device to emit light for a relatively short period. On the other hand, in the case of the active matrix type, an active device is used to control the quantity of current flowing in the organic light emitting device. As the active device, a thin film transistor (hereinafter, referred to as “TFT”) is widely used. The active matrix type organic electroluminescent display has a relatively complicated structure, but it consumes a relatively small amount of power, and yet it drives each organic light emitting device to emit light for a relatively long period.

Also, the life span of the organic light emitting device depends on the amount of current flowing therein. Because of this, when the organic light emitting device wastefully emits light at a high brightness, the amount of the current flowing in the organic light emitting device is increased, thereby shortening the life span of the organic light emitting device. Further, when the organic light emitting device wastefully emits light at a high brightness, the amount of the current flowing in the organic light emitting device is increased, thereby increasing power consumption. Therefore, the organic light emitting device should be controlled to emit proper brightness.

### SUMMARY OF THE INVENTION

An embodiment of the present invention provides an organic light emitting display and a control method thereof, which can use a gamma correction value corresponding to a neighboring brightness (or a brightness of a neighboring region) and can control the brightness of the display to vary depending on the neighboring brightness.

An embodiment of the present invention provides a fabricated organic light emitting display and a control method thereof, which can use a programmable memory for storing a gamma correction value to thereby program a gamma correction value suitable (or customized) for the fabricated organic light emitting display and/or a user.

An embodiment of the present invention provides a fabricated organic light emitting display and a control method thereof, which can use different gamma correction values according to red (R), green (G) and blue (B) to thereby correct a color coordinate value of a white light emitted by fabricated organic light emitting display.

One embodiment of the present invention provides an organic light emitting display including: an optical sensing part for outputting a sensed signal corresponding to a neighboring brightness of the organic light emitting display; a gamma controller for outputting a gamma correction value corresponding to the sensed signal; a driver for outputting a selection signal and a gamma-corrected data signal according to the gamma correction value; and an image displaying part for displaying an image according to the gamma-corrected data signal and the selection signal outputted from the driver.

In one embodiment of the invention, the gamma controller includes a sensed signal processor for outputting a storage control signal corresponding to the sensed signal; and a gamma correction value storage for outputting a gamma correction value according to the storage control signal. Further, in one embodiment of the invention, the gamma correction value storage includes a programmable memory. Also, in one embodiment of the invention, the gamma correction value include a plurality of different gamma correction value, and the gamma correction value storage stores the plurality of different gamma correction values according to red (R), green (G) and blue (B).

One embodiment of the present invention provides a method of controlling an organic light emitting display, the method including: sensing a neighboring brightness of the organic light emitting display; reading a gamma correction value corresponding to the sensed neighboring brightness from a gamma correction value storage for storing a plurality of gamma correction values; generating a selection signal and a gamma-corrected data signal based on the read gamma correction value; and displaying an image on an image displaying part of the organic light emitting display in accordance with the selection signal and the gamma-corrected data signal.

In one embodiment of the invention, the gamma correction value storage includes a programmable memory. Further, in one embodiment of the invention the gamma correction value includes a plurality of different gamma correction values, and the gamma correction value storage stores the plurality of different gamma correction values according to R, G and B.

### BRIEF DESCRIPTION OF THE DRAWINGS

The accompanying drawings, together with the specification, illustrate exemplary embodiments of the present invention, and, together with the description, serve to explain the principles of the invention.

FIG. 1 is a block diagram of an organic light emitting display according to a first embodiment of the present invention;

FIG. 2 is a perspective view of a terminal such as a mobile phone provided with an optical sensor according to the first embodiment of the present invention;

FIG. 3 is a view illustrating an A/D converter employed in the organic light emitting display according to the first embodiment of the present invention;

FIG. 4 is a graph showing a gamma correction value stored in a gamma correction value storage of the organic light emitting display according to the first embodiment of the present invention;

FIG. 5 shows color coordinates of x and y in order to illustrate the storing of the different gamma correction values according to R, G, B in a gamma correction value storage of an organic light emitting display according to an embodiment of the present invention;

FIG. 6 is a graph showing gamma correction values according to a sensing signal;

FIG. 7 is a view for illustrating a data driver employed in an organic light emitting display according to an embodiment of the present invention;

FIG. 8 is a view for illustrating a D/A converter employed in a data driver according to an embodiment of the present invention;

FIG. 9 is a circuit diagram of a pixel included in an image displaying part employed in the organic light emitting display according to the first embodiment of the present invention; and

FIG. 10 is a block diagram of an organic light emitting display according to a second embodiment of the present invention.

### DETAILED DESCRIPTION

In the following detailed description, only certain exemplary embodiments of the present invention are shown and described, simply by way of illustration. As those skilled in the art would realize, the described embodiments may be modified in various different ways, all without departing from the spirit or scope of the present invention.

FIG. 1 is a block diagram of an organic light emitting display according to a first embodiment of the present invention. As shown, the organic light emitting display according to the first embodiment of the present invention includes an optical sensing part 100, a gamma controller 200, a driver 300, and an image displaying part 400.

The optical sensing part 100 senses a neighboring brightness, and outputs a sensed signal corresponding to the neighboring brightness to the gamma controller 200. The optical sensing part 100 includes an optical sensor 110 and an analog/digital (A/D) converter 120. The optical sensor 110 senses the neighboring brightness, and outputs an analog sensed signal. Here, the analog sensed signal may be a voltage signal or a current signal. For example, the optical sensor 110 includes a photoresistor using a phenomenon that resistance of a resistor varies according to incident light; a photodiode using a phenomenon that current flows due to an electron-hole pair generated when light is emitted to a PN-junction of a semiconductor; a phototransistor amplifying photocurrent between a base and a collector of the photodiode; a complementary metal oxide semiconductor (CMOS); a charge-coupled device (CCD); etc. The A/D converter 120 converts the analog sensed signal output from the optical sensor 110 into a digital sensed signal.

The gamma controller 200 outputs a gamma correction value to the driver 300 in correspondence with the sensed signal output from the optical sensing part 100. The gamma controller 200 includes a sensed signal processor 210, and a gamma correction storage 220. The sensed signal processor 210 outputs a storage control signal for controlling the gamma correction value storage 220 to output the gamma correction value corresponding to the sensed signal. The gamma correction value storage 200 stores a plurality of gamma correction values corresponding to the sensed signals, and outputs the gamma correction value corresponding to the storage control signal to a gamma correction part 310. The gamma correction storage can store the different gamma correction values according to red (R), green (G) and blue (B). Here, the gamma correction value storage 220 may be a programmable memory. By way of example, the programmable memory includes a programmable read only memory (PROM) that allows programming only once; an erasable programmable read only memory (EPROM) that allows reprogramming; an electrically erasable programmable read only memory (EEPROM) that allows electrical reprogramming; a flash memory, etc. Here, the sensed signal processor 210 can be used to program the gamma correction value storage 220. Alternatively, a separate storage control unit may be used to program the gamma correction value storage 220. The gamma correction value storage 220 is programmable, so that it is possible to program and/or customize a suitable gamma correction value for the fabricated organic light emitting display and/or a user. In more detail, characteristics of fabricated image displaying parts (e.g., part 400) may be affected by variances in processing conditions, so that the characteristics of the fabricated image displaying parts may be varied according to the fabrication of the fabricated image displaying parts. Therefore, in a case of a non-programmable memory, because an invariable gamma correction value is applied to the fabricated image displaying parts, it may be inadequate to reflect the individual brightness characteristics of the fabricated image displaying part 400, so that the gamma correction may not be properly performed. Because of this, in one embodiment of the present invention, a programmable memory is used to store the gamma correction value suitable for the fabricated image displaying part 400, and therefore the organic light emitting display can have the desired brightness even though there may be differences in the processing conditions.

The driver 300 is employed to transmit the data signal to the image displaying part 400. The data signal is corrected using the gamma correction according to the selection signals and the gamma correction values. The driver 300 includes the gamma correction part 310, the data driver 320, and the scan driver 330. The gamma correction part 310 generates a gamma correction signal corresponding to the gamma correction value outputted from the gamma correction value storage 220, and outputs the gamma correction signal to the data driver 320. Then, the data driver 320 transmits the data signal to the image displaying part 400. The data signal is corrected using the gamma correction based on the gamma correction signal. Further, the scan driver 330 transmits the selection signal to the image displaying part 400.

The image displaying part 400 includes a plurality of pixels (not shown), and provides the data signal from the data driver 320 to the pixel selected by the selection signal of the scan driver 330, thereby allowing the pixel to emit light corresponding to the data signal. Because of this, the organic light emitting display of FIG. 1 operates to thereby display an image corresponding to the data signal inputted to the driver 300. Further, based on the gamma correction value corresponding to the sensed signal outputted from the optical sensing part 100, the brightness of the image displaying part 400 can be adjusted in correspondence with the neighboring brightness. Also, the programmable memory can be used as the gamma correction value storage 220, so that the gamma correction value suitable (or customized) for the fabricated image displaying part 400 can be stored in the storage 220. Also, based on the different gamma correction values according to R, G and B, the organic light emitting display of FIG. 1 can have a desired value for color coordinates of white.

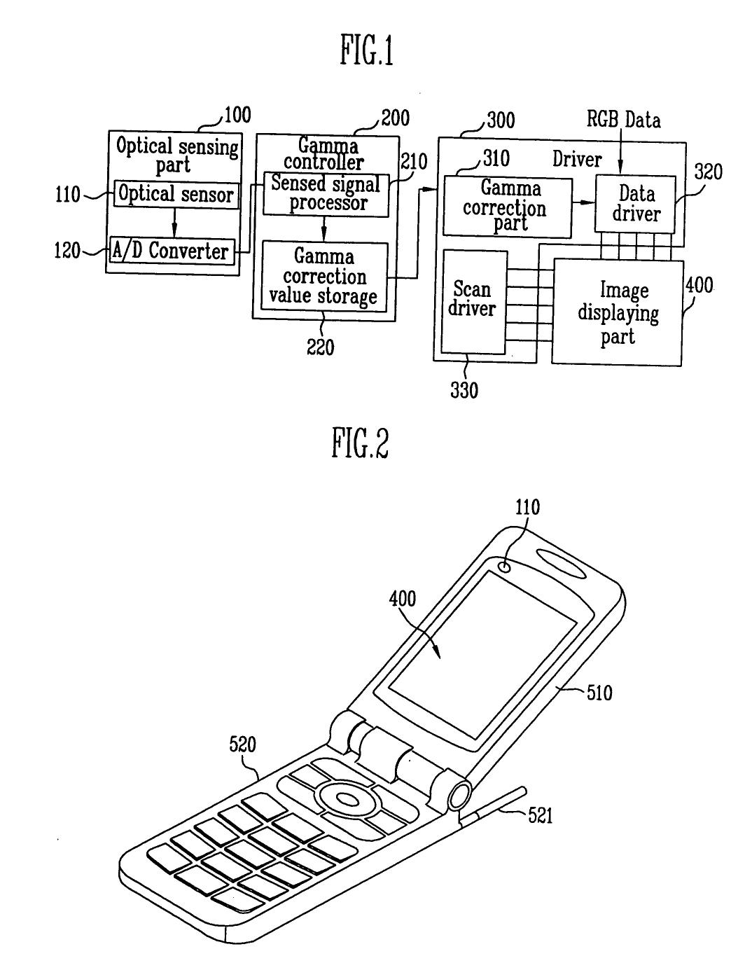

FIG. 2 is a perspective view of a terminal such as a mobile phone provided with an optical sensor according to the first embodiment of the present invention. As shown, the terminal includes the image displaying part 400, a first body 510, a second body 520, and the optical sensor 110.

The first body 510 and the second body 520 form a body of the terminal provided with the A/D converter 120, the gamma controller 200, and the driver 300. Further, the body of the terminal 510 and 520 includes an antenna 521, a radio frequency (RF) transceiver (not shown), and a baseband processor (not shown), thereby performing wireless communication.

The optical sensor 110 can be placed on any surface of the body of the terminal 510 and 520. In one embodiment, the optical sensor 110 is placed on the same surface as the image displaying part 400 is placed. That is, the brightness of the image displaying part 400 should be adjusted in correspondence to the incident brightness emitted toward (or the brightness falling upon) the image displaying part 400. However, since it is not easy to place the optical sensor 110 directly on the image displaying part 400, the optical sensor 110 in one embodiment is placed on the same surface of the terminal as the image displaying part 400 is placed, thereby sensing the brightness (or the neighboring brightness) of the nearest (or neighboring) light to the image displaying part 400. Further, the optical sensor 110 can be placed in upper, lower, left and/or right neighboring portions of the image displaying part 400 on the same surface of the terminal where the image displaying part 400 is placed.

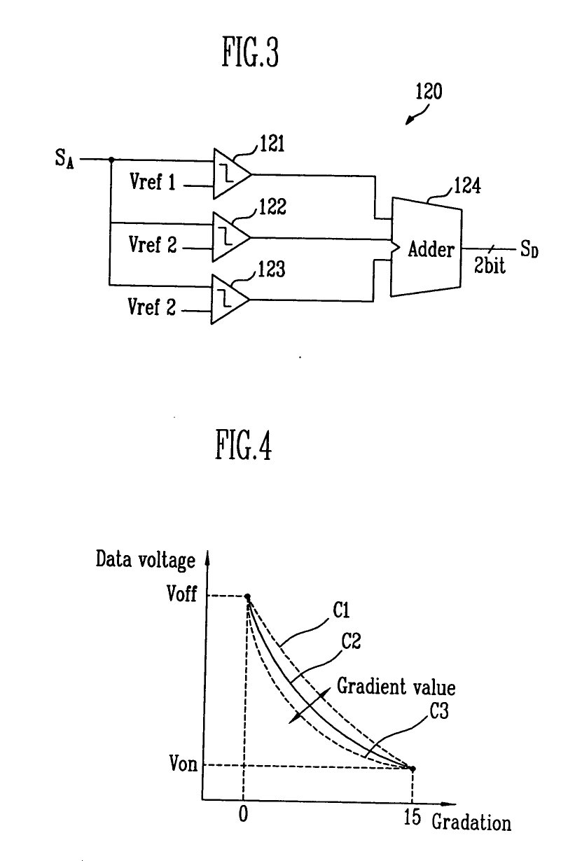

FIG. 3 is a view illustrating the A/D converter 120 employed in the organic light emitting display according to the first embodiment of the present invention. As shown, the A/D converter 120 includes a first comparator 121, a second comparator 122, a third comparator 123, and an adder 124. The first comparator 121 outputs a result of comparing an analog sensed signal S_{A} with a first reference voltage Vref1. In the case where the analog sensed signal S_{A} is higher than the first reference voltage Vref1, the first comparator 121 outputs ‘1’. By contrast, in the case where the analog sensed signal S_{A} is lower than the first reference voltage Vref1, the first comparator 121 outputs ‘0’. Likewise, the second comparator 122 outputs a result of comparing the analog sensed signal S_{A} with a second reference voltage Vref2. The third comparator 123 outputs a result of comparing the analog sensed signal S_{A} with a third reference voltage Vref3. Here, a range of the analog sensed signal S_{A} corresponding to the same digital sensed signal S_{D} can be changed by varying the first through third reference voltages Vref1, Vref2, Vref3. Further, the adder 124 outputs the digital sensed signal S_{D}, which can be in 2 bits, by adding the result outputted from the comparators 121, 122, 123 thereto.

Hereinafter, the AND converter 120 of FIG. 3 will be described on the assumption that the first reference voltage Vref1 is of ‘1V’; the second reference voltage Vref2 is of ‘2V’; the third reference voltage Vref3 is of ‘3V’; and the brighter the neighboring light is, the higher the voltage of the analog sensed signal S_{A} is. When the analog sensed signal S_{A} is lower than ‘1V’, the first through third comparators 121, 122 and 123 output ‘0’, ‘0’ and ‘0’, respectively, so that the adder 124 outputs the digital signal S_{D} of ‘00’. When the analog sensed signal S_{A} ranges between ‘1V’ and ‘2V’, the first through third comparators 121, 122 and 123 output ‘1’, ‘0’ and ‘0’, respectively, so that the adder 124 outputs the digital signal S_{D} of ‘01’. Likewise, when the analog sensed signal S_{A} ranges between ‘2V’ and ‘3V’, the adder 124 outputs the digital signal S_{D} of ‘10’. Further, when the analog sensed signal S_{A} is higher than ‘3V’, the adder 124 outputs the digital signal S_{D} of ‘11’. Thus, the A/D converter 120 divides the neighboring brightness into four levels, and outputs ‘00’ at the darkest case, ‘01’ at a certain dark case, ‘10’ at a certain bright case, and ‘11’ at the brightest case.

FIG. 4 is a graph showing a gamma correction value stored in a gamma correction value storage of the organic light emitting display according to the first embodiment of the present invention. As shown, a horizontal axis indicates gradation, and a vertical axis indicates a data voltage outputted from the driver 300 to the image displaying part 400. Here, the graph shows the data voltage corresponding to the gradation, which is called a gamma curve. The gamma correction corrects nonlinear characteristics in the brightness of the image displaying part 400 with regard to RGB data inputted to the driver 300. Further, an off-voltage Voff indicates voltage corresponding to black (a gradation of ‘0’), and an on-voltage Von indicates voltage corresponding to white (a gradation of ‘15’). Also, a gradient value indicates variance in a gradient. Referring to FIG. 4, the gradient of curve C2 is larger than that of curve C1 and smaller than that of curve C3.

The gamma correction values stored in the gamma correction value storage 220 can have all voltage levels (ranging from Von to Voff) corresponding to the respective gradations. In this case, the gamma correction is easily performed using the gamma correction values, but the storage 220 has to store all voltage levels corresponding to all gradations, thereby requiring a lot of memory. Alternatively, the gamma correction values stored in the gamma correction value storage 220 can have some voltage levels corresponding to some gradations. In this case, the other voltage levels can be calculated by interpolating the stored voltage levels. Further, the gamma correction values stored in the gamma correction value storage 220 can include the off-voltage Voff, the on-voltage Von, and the gradient value. Thus, each gamma curve shown in FIG. 4 can be calculated based on its off-voltage Voff, its on-voltage Von, and its gradient value. In the case where the off-voltage Voff is invariable, the gamma correction values can include only the on-voltage Von and the gradient value.

FIG. 5 shows color coordinates of x and y to illustrate the storing of the different gamma correction values according to R, G, B in a gamma correction value storage of an organic light emitting display according to an embodiment of the present invention.

In FIG. 5, a coordinate value of x on an X-axis and a coordinate value of y on a Y-axis are represented as equation 1.
x=X/(X+Y+Z), y=Y/(X+Y+Z) equation 1
where X is the brightness of red, Y is the brightness of green, and Z is the brightness of blue.

In FIG. 5, “W” indicates the color coordinates of white, e.g., x=0.31, y=0.316; “R” indicates a region representing color near red; “G” indicates a region representing color near green; and “B” indicates a region representing color near blue.

In a fabricated image displaying part, initial color coordinates of white can be deviated from the desired color coordinates of white and may be located in the red region “R”, the green region “G” or the blue region “B” because of the difference in the processing conditions. In this case, the gamma correction values are differently applied to red data, green data, and blue data, so that the color coordinates of the white can be corrected into the desired color coordinates.

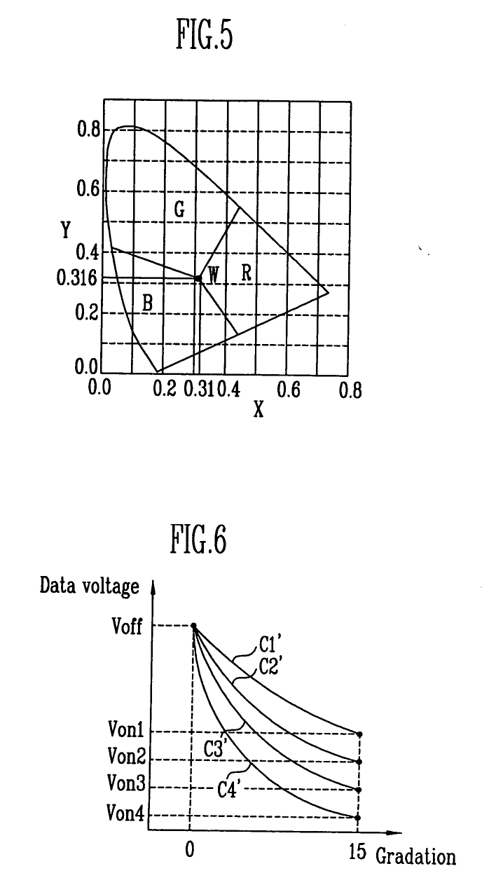

FIG. 6 is a graph showing gamma correction values according to a sensing signal. As shown, C1′ indicates a gamma curve corresponding to the sensed signal at the darkest case; C2′ indicates a gamma curve corresponding to the sensed signal at the certain dark case; C3′ indicates a gamma curve corresponding to the sensed signal at the certain bright case; and C4′ indicates a gamma curve corresponding to the sensed signal at the brightest case. In one embodiment, the gamma correction value storage 220 stores the gamma correction values (or on-voltages) Von1, Von2, Von3 and Von4 corresponding to the respective gamma curves C1′, C2′, C3′ and C4′, and stores the gradient values of the respective gamma curves C1′, C2′, C3′, and C4′.

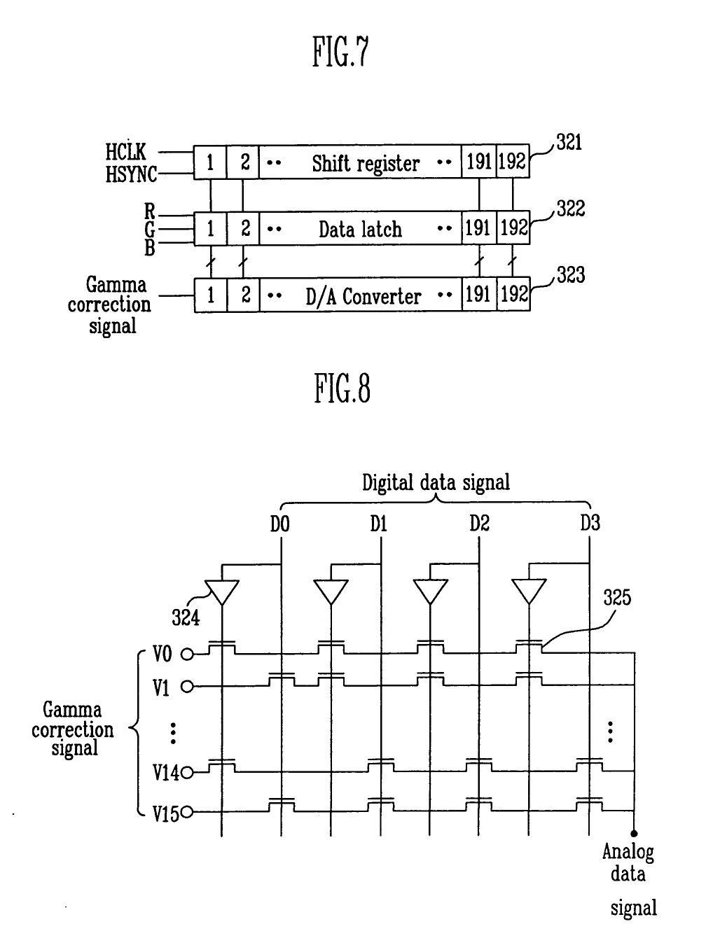

FIG. 7 is a view for illustrating a data driver (e.g., the data driver 320 of FIG. 1) employed in an organic light emitting display according to an embodiment of the present invention. As shown, the data driver includes a shift register 321, a data latch 322, and a digital/analog (D/A) converter 323. The shift register 321 controls the data latch 322 in correspondence with a horizontal clock signal HCLK and a horizontal synchronous signal HSYNC. The data latch 322 receives the RGB data corresponding to a horizontal line of the shift register 321 in sequence, and transmits them to the D/A converter 323 in parallel. At this time, the data latch 322 is controlled on the basis of a control signal outputted from the shift register 321. The D/A converter 323 converts the RGB data into the analog data signal, and transmits it to an image displaying part (e.g., the image displaying part 400 of FIG. 1). Further, the D/A converter 323 includes a plurality of D/A converting circuits (not shown). In each D/A converting circuit, current or voltage of the data signal corresponding to the respective gradations is determined according to one or more gamma correction signals.

FIG. 8 is a view for illustrating a D/A converter (e.g., the D/A converter 323 of FIG. 7) employed in a data driver according to an embodiment of the present invention, in which a digital data signal having 4 bits is illustrated. As shown, the D/A converter includes a plurality of inverters 324, and a plurality of NMOS (N metal oxide semiconductor) transistors 325. The digital data signals D₀, D₁, D₂ and D₃, which can be in 4 bits, and the signals (or inverted signals) from the digital data signals D₀, D₁, D₂ and D₃ passing through the inverters 324 are connected to the gate of each NMOS transistor 325, thereby turning on/off each NMOS transistor 325. The respective gamma correction signals V₀ through V₁₅ are connected to four NMOS transistors 325 connected in series. Therefore, when four NMOS transistors 325 are all turned on by the digital data signals D₀, D₁, D₂ and D₃ and the signals from the digital data signals D₀, D₁, D₂ and D₃ passing through the inverters 324, an analog data signal is outputted. For example, when the digital data signal is ‘0001’ as a binary number, that is, when D₀ is ‘1’, D₁ is ‘0’, D₂ is ‘0’ and D₃ is ‘0’, four NMOS transistors 325 connected to the gamma correction signal corresponding to “V₁” are all turned on, thereby outputting the analog data signal corresponding to “V₁”. At this time, at least one of four NMOS transistors 325 connected to the other respective gamma correction signals is turned off, so that the other gamma correction signals are not outputted as the analog data signal.

In the embodiment of FIG. 8, the gamma correction signals V₀ through V₁₅ are inputted corresponding to all gradations of each digital data signal D₀, D₁, D₂ and D₃. Alternatively, the gamma correction signals corresponding to some gradations of the digital data signal may be inputted, and the other gradations can be calculated by interpolating the inputted gamma correction signals.

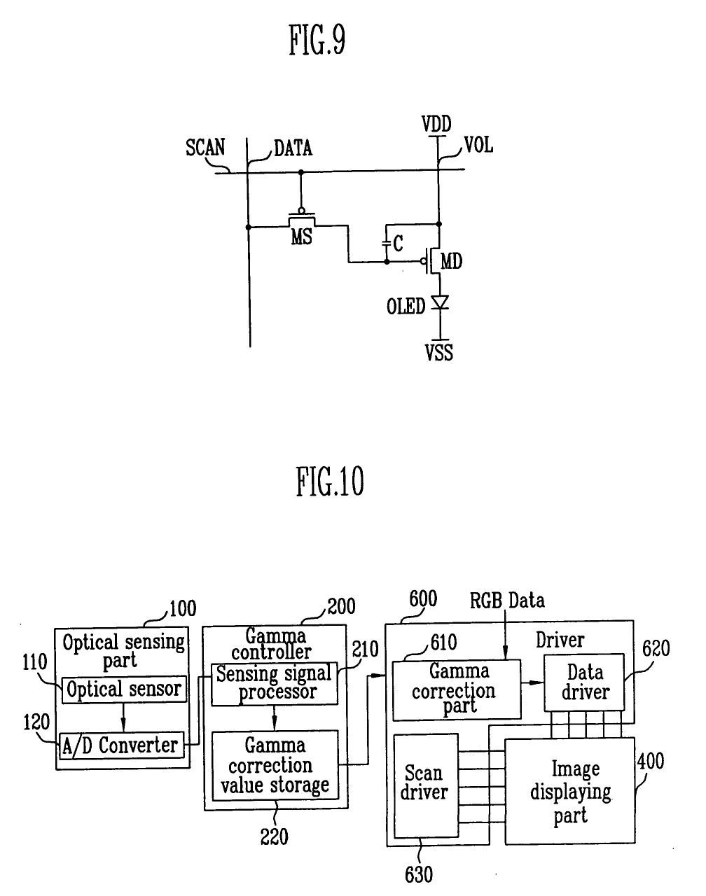

FIG. 9 is a circuit diagram of a pixel included in an image displaying part employed in the organic light emitting display according to the first embodiment of the present invention. As shown, the pixel of the organic light emitting display includes an organic light emitting device OLED, a driving transistor MD, a capacitor C, and a switching transistor MS. The driving transistor MD and the switching transistor MS can be realized by a thin film transistor. Each of the driving and switching transistors MD and MS has a gate, a source and a drain. The capacitor C includes a first terminal and a second terminal.

The switching transistor MS includes the gate connected to the scan line SCAN, the source connected to the gate of the driving transistor MD, and the drain connected to the data line DATA. Here, the switching transistor MS controls the capacitor C to store voltage corresponding to the data voltage applied to the data line DATA in response to the scan signal applied to the scan line SCAN.

The capacitor C includes the first terminal to which power voltage VDD is applied, and the second terminal connected to the gate of the driving transistor MD. Here, the capacitor C stores the voltage corresponding to the data voltage applied to the data line DATA while the switching transistor MS is turned on, and keeps the voltage while the switching transistor MS is turned off.

The driving transistor MD includes the gate connected to the second terminal of the capacitor C, the source to which the power voltage VDD is applied, and the drain connected to an anode electrode of the organic light emitting device OLED. Here, the driving transistor MD supplies a current corresponding to the voltage applied between the first and second terminals of the capacitor C to the organic light emitting display.

FIG. 10 is a block diagram of an organic light emitting display according to a second embodiment of the present invention. As shown, an organic light emitting display according to the second embodiment of the present invention includes an optical sensing part 100, a gamma controller 200, a driver 600, and an image displaying part 400. According to the second embodiment of the present invention, the optical sensing part 100, the gamma controller 200, and the image displaying part 400 have the same configuration as those of the first embodiment.

The driver 600 transmits a data signal to the image displaying part 400. The data signal is corrected by using gamma correction according to a selection signal and a gamma correction value. The driver 600 includes a gamma correction part 610, a data driver 620, and a scan driver 630. In the embodiment of FIG. 10, the gamma correction part 610 also receives RGB data, and outputs the gamma-corrected RGB data to the data driver 620. The data driver 620 outputs the data signal corresponding to the gamma-corrected RGB data to the image displaying part 400. The scan driver 630 transmits the selection signal to the image displaying part 400.

In more detail, the gamma correction part 610 and the data driver 620 will be described hereinbelow with respect to FIGS. 4 and 10. The gamma correction part 610 outputs the data voltages corresponding to the respective gradations of the RGB data as the gamma-corrected RGB data. In the case where each gradation of the RGB data is ‘0’, off-voltage Voff is outputted as the gamma-corrected RGB data. The data driver 620 outputs the data signal corresponding to the gamma-corrected RGB data. The gradations of the gamma-corrected RGB data linearly correspond to the level of the data signals. That is, the level of the data signal is increased in proportion to the gradation of the gamma-corrected RGB data.

In general, an embodiment of the present invention provides an organic light emitting display and a control method thereof, which can use a gamma correction value corresponding to a neighboring brightness and can control the brightness of the display to vary depending on the neighboring brightness, thereby lengthening lifespan of a pixel of the display and reducing power consumption.

Further, an embodiment of the present invention provides a fabricated organic light emitting display and a control method thereof, which can use a programmable memory for storing a gamma correction value to thereby program a gamma correction value suitable for the fabricated organic light emitting display and/or a user.

Also, an embodiment of the present invention provides a fabricated organic light emitting display and a control method thereof, which can use different gamma correction values according to R, G and B to thereby correct a color coordinate value of a white light emitted by the fabricated organic light emitting display.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. An organic light emitting display comprising:
an optical sensing part for outputting a sensed signal corresponding to a neighboring brightness of the organic light emitting display;
a gamma controller for outputting a gamma correction value corresponding to the sensed signal;
a driver for outputting a selection signal and a gamma-corrected data signal according to the gamma correction value; and
an image displaying part for displaying an image according to the gamma-corrected data signal and the selection signal outputted from the driver.

2. The organic light emitting display according to claim 1, wherein the optical sensing part comprises:
an optical sensor for outputting an analog sensed signal corresponding to the neighboring brightness; and
an analog/digital (A/D) converter for converting the analog sensed signal into the sensed signal, wherein the sensed signal is a digital sensed signal.

3. The organic light emitting display according to claim 2, wherein the optical sensor includes a photoresistor, a photodiode, a phototransistor, a complementary metal oxide semiconductor (CMOS), and/or a charge-coupled device (CCD).

4. The organic light emitting display according to claim 2, wherein the AND converter comprises:
a plurality of comparators, each of the plurality of comparators being for outputting a result of comparing the analog sensed signal with a predetermined reference signal; and
an adder for adding the results outputted by the comparators.

5. The organic light emitting display according to claim 1, wherein the gamma controller comprises:
a sensed signal processor for outputting a storage control signal corresponding to the sensed signal; and
a gamma correction value storage for outputting a gamma correction value according to the storage control signal.

6. The organic light emitting display according to claim 5, wherein the gamma correction value storage includes a programmable memory.

7. The organic light emitting display according to claim 6, wherein the programmable memory includes a programmable read only memory (PROM), an erasable programmable read only memory (EPROM), an electrically erasable programmable read only memory (EEPROM), and/or a flash memory.

8. The organic light emitting display according to claim 5, wherein the gamma correction value comprises a plurality of different gamma correction values and wherein the gamma correction value storage stores the plurality of different gamma correction values according to red (R), green (G) and blue (B).

9. The organic light emitting display according to claim 5, wherein the gamma correction value includes:
an on-voltage value corresponding to a gradation of white; and
a gradient value for indicating a variance in a gradient of a gamma curve.

10. The organic light emitting display according to claim 9, wherein the gamma correction value further includes an off-voltage value corresponding to a gradation of black.

11. The organic light emitting display according to claim 1, wherein the driver comprises:
a gamma correction part for outputting a gamma correction signal corresponding to the gamma correction value;
a data driver for outputting the gamma-corrected data signal corresponding to the gamma correction signal; and
a scan driver for outputting the selection signal.

12. The organic light emitting display according to claim 11, wherein the data driver comprises:
a shift register for outputting a latch control signal corresponding to a clock signal and a synchronization signal;
a data latch for sequentially receiving and for parallel outputting RGB data according to the latch control signal; and
a digital/analog (D/A) converter for converting the RGB data outputted by the data latch into an analog signal and for outputting the analog signal as the data signal, wherein the data signal corresponding to each gradation is determined by the gamma correction signal.

13. The organic light emitting display according to claim 1, wherein the driver comprises:
a gamma correction part for receiving input RGB data and for applying gamma correction to the input RGB data corresponding to the gamma correction value;
a data driver for outputting the data signal corresponding to the gamma-corrected RGB data; and
a scan driver for outputting the selection signal.

14. A method of controlling an organic light emitting display, the method comprising:
sensing a neighboring brightness of the organic light emitting display;
reading a gamma correction value corresponding to the sensed neighboring brightness from a gamma correction value storage for storing a plurality of gamma correction values;
generating a selection signal and a gamma-corrected data signal based on the read gamma correction value; and
displaying an image on an image displaying part of the organic light emitting display in accordance with the selection signal and the gamma-corrected data signal.

15. The method according to claim 14, wherein the gamma correction value storage includes a programmable memory.

16. The method according to claim 15, wherein the programmable memory includes a programmable read only memory (PROM), an erasable programmable read only memory (EPROM), an electrically erasable programmable read only memory (EEPROM), and/or a flash memory.

17. The method according to claim 14, wherein the gamma correction value comprises a plurality of different gamma correction values and wherein the gamma correction value storage stores the plurality of different gamma correction values according to red (R), green (G) and blue (B).

18. The method according to claim 14, wherein the gamma correction value includes:
an on-voltage value for corresponding to a gradation of white; and
a gradient value for indicating a variance in a gradient of a gamma curve.

19. The method according to claim 18, wherein the gamma correction value further includes an off-voltage value corresponding to a gradation of black.

20. An organic light emitting display comprising:
means for sensing a neighboring brightness of the organic light emitting display;
means for reading a gamma correction value corresponding to the sensed neighboring brightness from a plurality of stored gamma correction values;
means for generating a selection signal and a gamma-corrected data signal based on the read gamma correction value; and
means for displaying an image on an image displaying part of the organic light emitting display corresponding with the selection signal and the gamma-corrected data signal.
